(19) United States
(12) Patent Application Publication
(10) Pub. No.: US 2026/0011198 A1
(43) Pub. Date: Jan. 8, 2026

(54) MULTI-FACTOR AUTHENTICATION FOR THIRD-PARTY DELIVERY SERVICE PROVIDERS

(71) Applicant: The ADT Security Corporation, Boca Raton, FL (US)

(72) Inventor: Tai NGUYEN, Glenside, PA (US)

(21) Appl. No.: 18/763,489

(22) Filed: Jul. 3, 2024

(51) Int. Cl. G07C 9/27; G07C 9/00

(52) U.S. Cl. CPC G07C 9/27; G07C 9/00309; G07C 9/00571; G07C 2209/08

(57) ABSTRACT

According to some embodiments, at least one computing device is provided. The at least one computing device receives an image of an optically capturable passcode, the image being captured by a premises monitoring system, receives recorded audio of audio rendered by a mobile device and captured by the premises monitoring system, the audio rendered by the mobile device comprising an audio passcode, authenticates a person associated with the mobile device based on the optically capturable passcode and the audio passcode, determines that the person is permitted access to the premises according to an access policy, and in response to authenticating the person and determining that the person is permitted access to the premises, causes a lock securing an access point of the premises to unlock.

### TECHNICAL FIELD

The present technology is generally related to multi-factor authentication for controlling access to premises monitored by a premises monitoring system.

### BACKGROUND

There may be various reasons why people give access to their homes to neighbors, friends, family, delivery workers, service workers, etc. For example, a person may be out of town and need someone to look after the home and/or pets at the home. In another example, the person may be out of town but may have a company that provides recurring maintenance or service to the home or may expect an important delivery that would be safer if stored inside the home rather than remaining in front of the door or on the front porch.

The person may be left with limited options for providing access to the home while away. For example, the person may provide a neighbor with the physical home key and/or share a personal identification number (PIN) to a smart door lock or keep a backdoor unlocked on a particular date and time. However, the person who is away from the home is left with limited options for verifying who accessed the home, when the home was accessed, and why the home was accessed.

Further, companies that provide in-home grocery delivery may have issues with a home’s security system as the homeowner or person who is away from the home may forget to disarm the security system on the grocery delivery day. That is, even though the delivery person may have a physical home key and/or a PIN to a smart door lock, the armed security system will still trigger, which results in a false alarm and possibly monetary fines in certain jurisdictions. Even if the homeowner or person who is away from the home remembers to disarm the security system to mitigate the problem of false alarms, disarming the security system while the person is away from the home may negate the value of having a security system, since the home may be left unprotected by the security system for the entire day due to what amounts to a quick, e.g., 15-minute delivery.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a block diagram of an example system according to some embodiments of the present disclosure;

FIG. 2 is a block diagram of another example system according to some embodiments of the present disclosure;

FIG. 3 is a block diagram of an example control device of FIG. 1 and/or FIG. 2 according to some embodiments of the present disclosure;

FIG. 4 is a block diagram of example premises devices of FIG. 1 and/or FIG. 2 according to some embodiments of the present disclosure;

FIG. 5 is a block diagram of a mobile device of FIG. 1 and/or FIG. 2 according to some embodiments of the present disclosure;

FIG. 6 is a block diagram of an example computing device of FIG. 1 and/or FIG. 2 according to some embodiments of the present disclosure;

FIG. 7 is an example signaling diagram according to some embodiments of the present disclosure;

FIG. 8 is another example signaling diagram according to some embodiments of the present disclosure;

FIG. 9 is another example signaling diagram according to some embodiments of the present disclosure; and

FIGS. 10A-10B is a flowchart of an example process according to some embodiments of the present disclosure.

### DETAILED DESCRIPTION

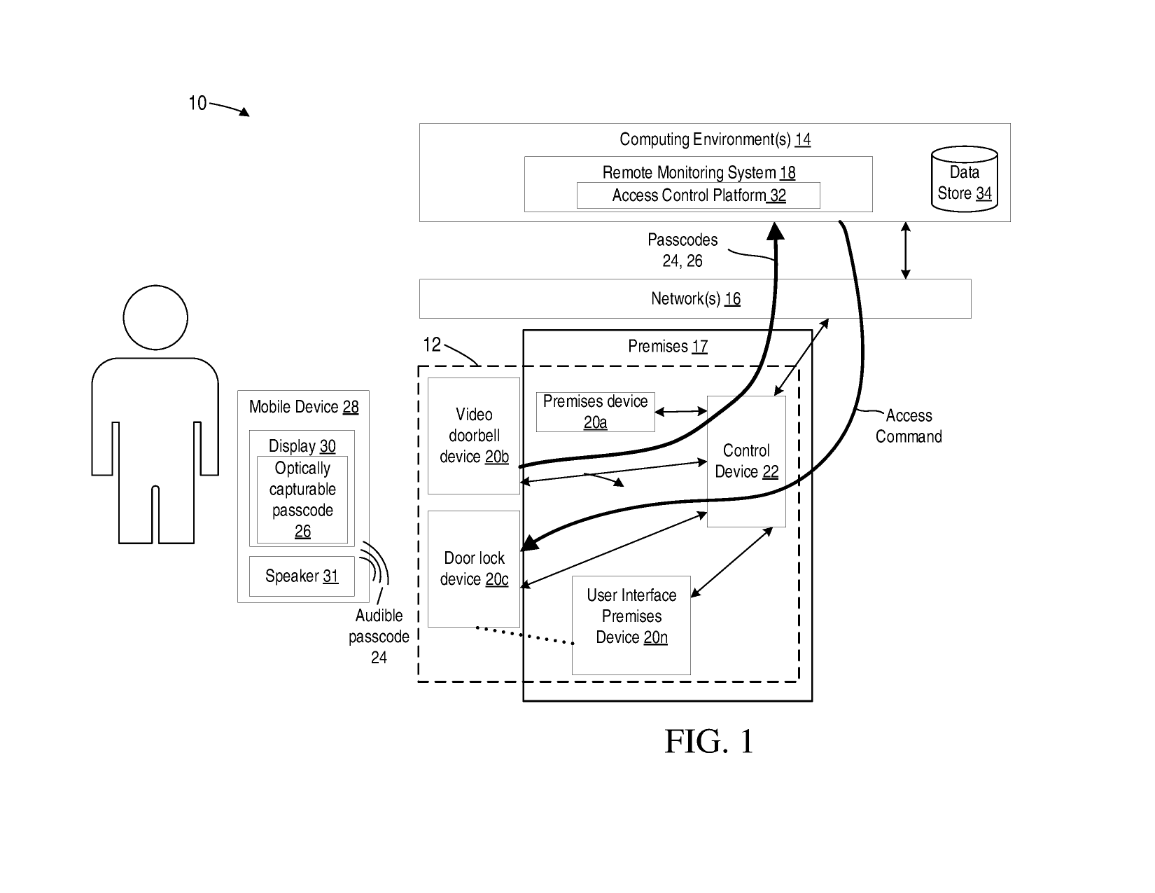

With reference to FIG. 1, shown is a block diagram of an example system 10 according to some embodiments of the present disclosure. System 10 may include premises monitoring system 12 and one or more computing environments 14 that may be in communication with each other via one or more networks 16 (collectively referred to as network 16). Premises monitoring system 12 may be configured to provide functionality relating to monitoring premises 17. For example, premises monitoring system 12 may be used to detect burglaries, smoke, fires, carbon monoxide leaks, water leaks, etc., and report detected events to remote monitoring system 18 of computing environment 14. Additionally, the premises monitoring functionality performed by premises monitoring system 12 may include home automation functionality. Examples of home automation functionality include thermostat control, door lock control, lighting control, appliance control, entertainment system control, etc.

Premises monitoring system 12 may include one or more premises devices 20a-20n (collectively referred to as “premises devices 20”) for providing one or more of monitoring functionality, home automation functionality, etc. Premises device 20 may be in communication with control device 22 via one or more networks such as, for example, a local area network at premises 17 and/or short-range wireless protocol network (e.g., BLUETOOTH, BLUETOOTH LOW ENERGY (BLE), ultra-wideband (UWB), ZIGBEE, Z-WAVE, other Institute of Electrical and Electronics Engineers (IEEE) based wireless protocols, etc.), Digital Enhanced Cordless Telecommunications (DECT) protocol, and/or other protocols. Premise devices 20 may include one or more sensors, devices configured to capture audio, images, and/or video, and/or other devices. For example, premises devices 20 may include motion sensors, fire sensors, smoke sensors, heat sensors, carbon monoxide sensors, flood sensors, flow sensors, level sensors, temperature sensors, humidity sensors, proximity sensors, contact sensors, glass break sensors, water consumption sensors, water pressure sensors, etc. Devices configured to capture audio, images, and/or video may include still image cameras, video cameras, microphones, etc. Additional examples of premises devices 20 include sirens, garage door controllers, doorbells (e.g., configured to capture audio, images and/or video), temperature sensors, humidity sensors, lighting devices, switches, electrical outlets, door locks, premises locks, and electrical plugs.

In one or more embodiments, premises device 20b is a video doorbell device 20b that is configured to capture media such as audio (e.g., audio passcode(s) 24), one or more images (e.g., including optically capturable passcode(s) 26 such as QR code 26 displayed on display 30 of mobile device 28), and/or video. To this end, video doorbell device 20b may include still image cameras, video cameras, microphones, etc. As an example, the video doorbell device 20b may be a networked-connected doorbell (e.g., a “smart” doorbell) that has one or more cameras, microphones, network interfaces, and/or other electronic components.

In various examples, a mobile device 28 comprises a display 30 that is configured to display an optically capturable passcode 26 that video doorbell device 20b captures as part of a multi-factor authentication process described herein. Mobile device 28 may be a handheld delivery personnel device (e.g., a Delivery Information Acquisition Device (DIAD)) carried by a delivery person or a smartphone with third-party software for performing the authentication steps described herein. Further, mobile device 28 is configured to audibly emit audio passcode 24 (e.g., via speaker 31) that video doorbell device 20b captures as part of a multi-factor authentication process described herein. In various embodiments, authentication data (e.g., passcodes 24 and 26) are transmitted to computing environment 14 via control device 22 and network 16, as described herein.

In one or more embodiments, premises device 20n is a user interface premises device 20n that may include a user interface, such as one or more buttons, a touch screen, a display, a microphone, a speaker, and/or other types of user interface components, to facilitate a user interacting with control device 22 for controlling the premises monitoring system 12.

Premises monitoring system 12 further comprises control device 22 that may be configured to control various aspects of premises monitoring system 12. For example, control device 22 may be configured to control premises devices 20, such as locks, doors, windows, actuators, valves, motors, and any other controllable devices associated with premises monitoring system 12. A control device 22 in various embodiments may include a user interface, such as one or more buttons, a touch screen, a display, a microphone, a speaker, and/or other types of user interface components, to facilitate a user interacting with and controlling the premises monitoring system 12. The control device 22 may also be configured to communicate with one or more components of computing environment 14. Furthermore, the control device 22 may be configured to transmit data received from one or more premises devices 20 to components of computing environment 14. According to various embodiments, control device 22 may be a gateway device, a hub, an alarm system panel, and/or another type of device configured to control aspects of premises monitoring system 12.

Further, computing environment 14 may include remote monitoring system 18, access control platform 32 and data store 34. In one or more embodiments, access control platform 32 is part of and/or a sub-component of remote monitoring system 18. Remote monitoring system 18 may be configured to provide remote monitoring services for multiple premises monitoring systems 12. For example, in the event that an open door, open window, glass break, etc. is detected by a premises device 20 when premises monitoring system 12 is in an armed state, premises monitoring system 12 may transmit an alarm signal to remote monitoring system 18. In response, the remote monitoring system 18 and/or a human agent associated with remote monitoring system 18 may notify a public safety answering point (PSAP) for first responders, such as police, fire, emergency medical responders, etc., and/or one or more designated users associated with the premise monitoring system 12 via electronic messages and/or telephone calls.

Access control platform 32 of remote monitoring system 18 may be configured to allow temporary access (e.g., time-based access, alarm-based access, event-based access, guest access, etc.) to premises 17 to one or more people based on whether various authentication data (e.g., audio passcode 24, optically capturable passcode 26, etc.) meets at least one authentication criterion that may be stored in data store 34. In particular, access control platform 32 may be configured to provide one or more types of access to premises 17 via premises monitoring system 12. For example, certain types of users may be provided access to premises 17 for different types of access control. Different types of people may include the family of at least one person associated with premises 17 and neighbors with respect to premises 17 that are configured for access to premises 17 according to one or more access control levels. Further, another type of user may comprise one or more guests, vendors, and/or service providers that may be associated with different types of access control for being granted access to premises 17.

Further, the different types of access control may comprise one or more of time-based access, alarm-based access, event-based access or guest-based access. Time-based access may provide a person with limited time to access one or more portions of premises 17, such as when a homeowner, resident, or other person associated with premises 17 is temporarily away from premises 17 and may want someone to enter premises 17 for a limited amount of time. Alarm-based access may correspond to access that is triggered by an alarm event, such as an alarm event detected by a premises monitoring system 12, which may include, for example, leak detection alarms, smoke alarms, etc. and/or other event that may indicate a danger to life or property. Hence, controlled access to the premises may be provided in response to one or more alarms, such as to allow other users and/or first responders access to the premises 17.

Event-based access may correspond to providing access to premises 17 based on an event detected by premises monitoring system 12. For example, a fall may be detected by computing environment 14 and/or components of premises monitoring system 12 based on analytics performed on video recorded by a premises device 20 such that a person may be granted access to premises 17, after authentication described herein, to help the individual who fell. Guest-based access may comprise providing a guest (or helper, service person, etc.) access to premises 17 for a specific purpose. For example, the guest may be a dog walker who requires temporary access to premises 17 to get and walk the dog.

Further, access control platform 32 may be configured to perform functionality related to granting access, if any, to an authenticated person. For example, access control platform 32 may be configured to authenticate a person, and in response, retrieve access data or an access profile for the authenticated person. The access data or access profile may be stored in data store 34 and may indicate the one or more types of access control that are applicable to the user and one or more rules (e.g., criterion, criteria, access policies) that specify when to grant access. That is, one or more pre-configured rules may be stored in data store 34 and specify the type(s) of authentication acceptable for a particular user and how many authentication factors are required for the access control platform 32 to grant the person access to premises 17. The one or more rules may be based on one or more of: day(s) of the week, time(s) of day, type of triggered alarm, type of detected event, type of vendor, the purpose of the person accessing the premises 17, etc. Access control platform 32 may function as a rules engine and may ensure premises monitoring system 12 is disarmed prior to unlocking a door to prevent false alarms.

In one or more embodiments, one or more types of access can be combined with additional rules or conditions, such as rules or conditions based on one or more of time of day, day of the month, premises monitoring system 12 modes (e.g., armed away, vacation mode, etc.) or a number of occurrences. The number of occurrences may correspond to the number of times a person is allowed entry to premises 17 within a predefined time window, such as one access attempt on Tuesday where subsequent access attempts on Tuesday will fail.

Data store 34 may be configured to store various information and/or data associated with authenticating a person as described herein. For example, data store 34 may store at least one authentication criterion (e.g., a rule) that specifies one or more conditions required for a person to be deemed authenticated for the purpose of granting the person access to premises 17. In some embodiments, the authentication criteria define one or more rules that must be satisfied for a person to be deemed authenticated for the purpose of granting access to premises 13. One example of a rule requires authentication to occur, within a time window, based on two or more forms of authentication data (e.g., audio passcode 24, optically capturable passcode 26, etc.). The time window may be initiated, for example, upon the access control platform 32 receiving the first authentication data. For example, in response to receiving first authentication data (e.g., optically capturable passcode 26), remote monitoring system 18 or access control platform 19 may trigger a countdown timer and an indication for a person to initiate or trigger mobile device 28 to audibly emit, via speaker 31, the audio passcode 24, and the second authentication data (e.g., an audio passcode 24) may be required to be received before expiration of the timer in order to meet a rule.

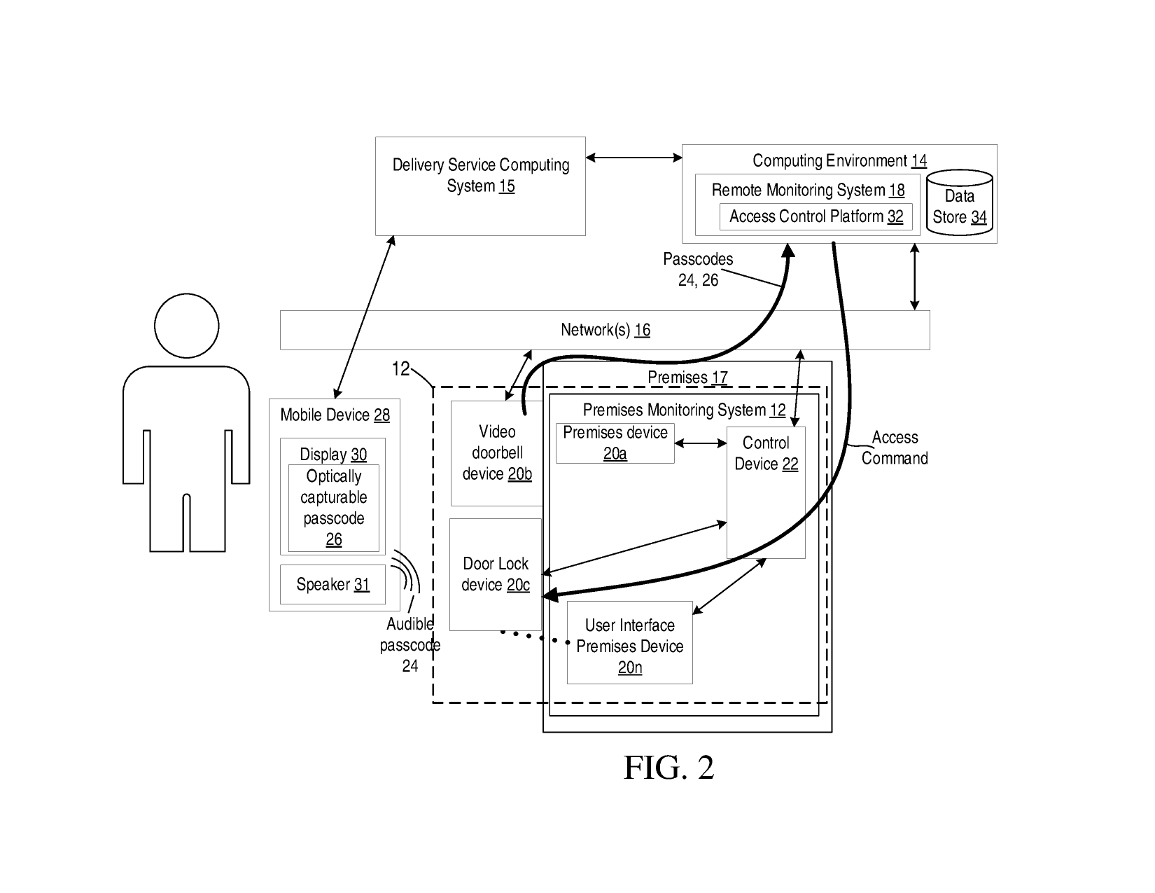

FIG. 2 is a diagram of another example embodiment of a system 10. In the example depicted in FIG. 2, system 10 includes computing environment 14 and a delivery service computing system 15. In various embodiments, the delivery service computing system 15 may be a computing system operated by a third party relative to the operator and/or service provider of the remote monitoring system 18 and/or access control platform 32. For example, delivery service computing system 15 may be operated by a delivery service provider or other service provider whose employee may need access to a customer’s premises. For example, the delivery service computing system 15 may be operated by a company that provides transportation and/or delivery of mail, parcels, gifts, flowers, food, etc.

In the example system 10 of FIG. 2, the mobile device 28 is configured to communicate with the delivery service computing system 15. Delivery service computing system 15 may be configured to request and store data (e.g., audio passcode 24, optically capturable passcode 26, etc.) received from computing environment 14 and perform one or more functions associated with the data it receives and/or stores. The delivery service computing system 15 may also be configured to communicate with one or more components of the computing environment 14. For example, the delivery service computing system 15 and the remote monitoring system of the computing environment 14 may use one or more application programming interfaces (APIs) to facilitate the transmission and receiving of information.

In some embodiments, in response to one or more components of the delivery service computing system 15 receiving audio passcode 24 and/or optically capturable passcode 26, one or more components of the delivery service computing system 15 are configured to transmit to the mobile device 28 the passcode 24 and/or the passcode 26.

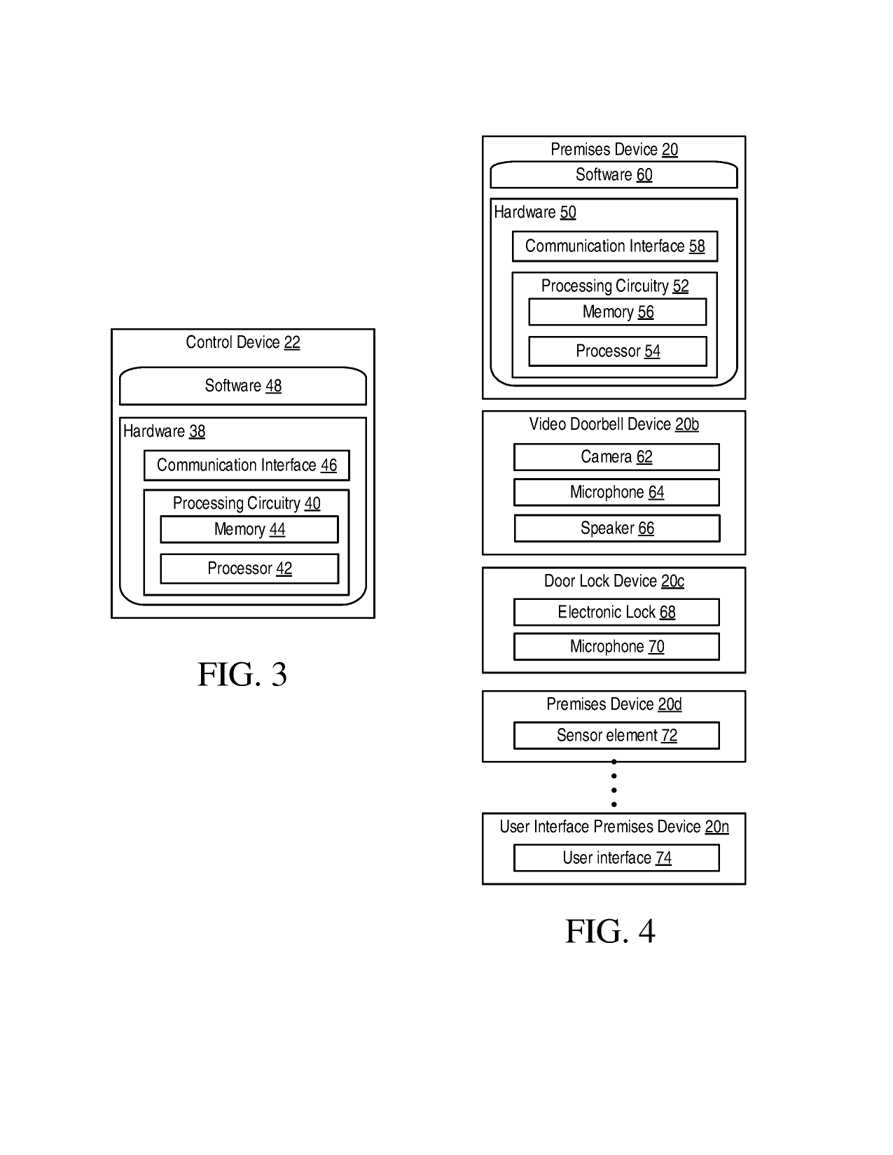

Referring now to FIG. 3, there is shown a block diagram illustrating an example control device 22 of premises monitoring system 12. As shown, control device 22 comprises hardware 38. The hardware 38 may include processing circuitry 40. The processing circuitry 40 may include one or more processors 42 and one or more memories 44. Each processor 42 may include and/or be associated with one or more central processing units, data buses, buffers, and interfaces to facilitate operation. In addition to or instead of a processor 42 and memory 44, the processing circuitry 40 may comprise other types of integrated circuitry that perform various functionality. Integrated circuitry may include one or more processors 42, processor cores, field programmable gate arrays (FPGAs), application specific integrated circuits (ASICs), graphics processing units (GPUs), Systems on Chips (SoCs), or other components configured to execute instructions. The processor 42 may be configured to access (e.g., write to and/or read from) the memory 44, which may comprise any kind of volatile and/or nonvolatile memory, e.g., cache, buffer memory, random access memory (RAM), read-only memory (ROM), optical memory, and/or erasable programmable read-only memory (EPROM). Further, memory 44 may be embodied in the form of one or more storage devices. The processing circuitry 40 may be configured to perform various functionality described herein. For example, computer instructions may be stored in memory 44 and/or another computer-readable medium that, when executed by processor 42, causes the processor 42 to perform various functionality described herein.

Hardware 38 may include communication interface 46 facilitating communication between control device 22 and one or more elements in system 10. For example, communication interface 46 may be configured for establishing and maintaining at least a wireless or wired connection with one or more elements of system 10 such as premises devices 20 and/or computing environment 14.

Control device 22 further has software 48 (which may include one or more software applications) stored internally in, for example, memory 44, or stored in external memory (e.g., database, storage array, network storage devices, etc.) accessible by the control device 22 via an external connection. Software 48 may include any software or program that configures processing circuitry 40 to perform the steps or processes of the present disclosure.

The processing circuitry 40 may be configured to control any of the methods and/or processes described herein and/or to cause such methods, and/or processes to be performed, e.g., by control device 22. Processor 42 corresponds to one or more processors 42 for performing control device 22 functions described herein. The memory 44 is configured to store data and/or files and/or other information/data. In some embodiments, the software 48 may include instructions that, when executed by the processor 42 and/or processing circuitry 40, causes the processor 42 and/or processing circuitry 40 to perform the processes described herein with respect to control device 22. Accordingly, by having computer instructions stored in memory 44 accessible to the processor 42, the processor 42 may be configured to perform the actions described herein.

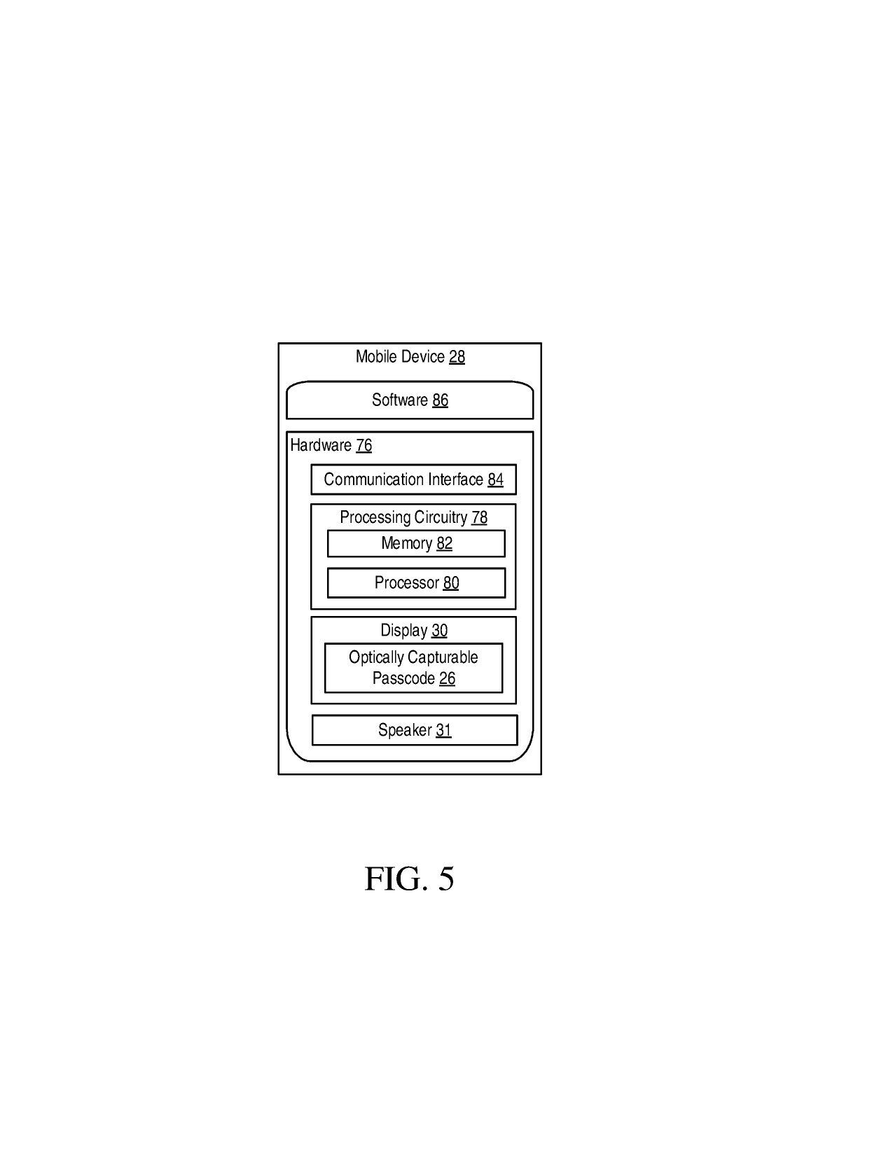

FIG. 4 is a block diagram illustrating several example premises devices 20a-n (referred to collectively herein as premises devices 20) according to some embodiments of the present disclosure. As shown, premises device 20a comprises hardware 50. The hardware 50 may include processing circuitry 52. The processing circuitry 52 may include one or more processors 54 (i.e., one or more premises device processors) and one or more memories 56. Each processor 54 may include and/or be associated with one or more central processing units, data buses, buffers, and interfaces to facilitate operation. In addition to or instead of a processor 54 and memory 56, the processing circuitry 52 may comprise other types of integrated circuitry that performs various functionality. Integrated circuitry may include one or more processors 54, processor cores, FPGAs, ASICs, GPUs, SoCs, or other components configured to execute instructions. The processor 54 may be configured to access (e.g., write to and/or read from) the memory 56, which may comprise any kind of volatile and/or nonvolatile memory, e.g., cache, buffer memory, RAM, ROM, optical memory, and/or EPROM. Further, memory 56 may be embodied in the form of one or more storage devices. The processing circuitry 52 may be configured to perform various functionality described herein. For example, computer instructions may be stored in memory 56 and/or another computer-readable medium that, when executed by processor 54, causes the processor 54 to perform various functionality associated premises device 20a.

Hardware 50 may include communication interface 58 facilitating communication between premises device 20a and one or more elements in system 10. For example, communication interface 58 may be configured for establishing and maintaining at least a wireless or wired connection with one or more elements of system 10 such as control device 22 and/or computing environment 14.

Premises device 20a further has software 60 (which may include one or more software applications) stored internally in, for example, memory 56, or stored in external memory (e.g., database, storage array, network storage devices, etc.) accessible by the premises device 20a via an external connection. Software 60 may include any software or program that configures processing circuitry 52 to perform the steps or processes of the present disclosure.

The processing circuitry 52 may be configured to control any of the methods and/or processes described herein and/or to cause such methods, and/or processes to be performed, e.g., by premises device 20a. Processor 54 corresponds to one or more processors 54 for performing premises device 20a functions described herein. The memory 56 is configured to store data and/or files and/or other information/data. In some embodiments, the software 60 may include instructions that, when executed by the processor 54 and/or processing circuitry 52, causes the processor 54 and/or processing circuitry 52 to perform the processes described herein with respect to premises device 20a. Accordingly, by having computer instructions stored in memory 56 accessible to the processor 54, the processor 54 may be configured to perform the actions described herein.

With reference to the video doorbell device 20b in FIG. 4, in one or more embodiments, video doorbell premises device 20b includes the same or similar hardware as premises device 20a described above, except that doorbell premises device 20b further includes one or more of camera 62, microphone 64 or speaker 66. Camera 62 is configured to capture media such as, for example, at least one of video or still images. Microphone 64 is configured to capture media such as, for example, audio proximate microphone 64. In one example, microphone 64 may capture an audio password output by speaker 31. Speaker 66 may be configured to emit one or more audio sounds.

In one or more embodiments, doorbell premises device 20b may be a networked doorbell having a camera 62 and a microphone 64.

With reference to the door lock device 20c in FIG. 4, in one or more embodiments, door lock device 20c includes the same or similar hardware as premises device 20a described above, except that door lock device 20c further includes electronic lock 68. For example, electronic lock 68 may comprise an electrically actuatable door locking mechanism where door lock device 20c may receive a command to lock or unlock the door locking mechanism and actuate the door locking mechanism according to the command. In one or more embodiments, door lock device 20c is positioned at and/or proximate to an access point or location of premises 17. In some embodiments, door lock device 20c may include microphone 70 for capturing audio sounds such as, for example, audio passcode 24.

In one or more embodiments, premises device 20d includes the same or similar hardware as premises device 20a described above, except that door lock device 20c further includes one or more sensor elements 72 configured to sensing as described herein. In one or more embodiments, premises device 20n is a monitoring interface device that includes the same or similar hardware as premises device 20a described above, except that premises device 20n further includes user interface 74 such as a control panel touchscreen or buttons to allow a user to interface with premises device 20n. In other words, each premises device 20 may comprise hardware and software that is similar to the hardware and software described with respect to premises device 20a, but with other elements to provide desired functionality, e.g., sensing, locking, user interface, etc.

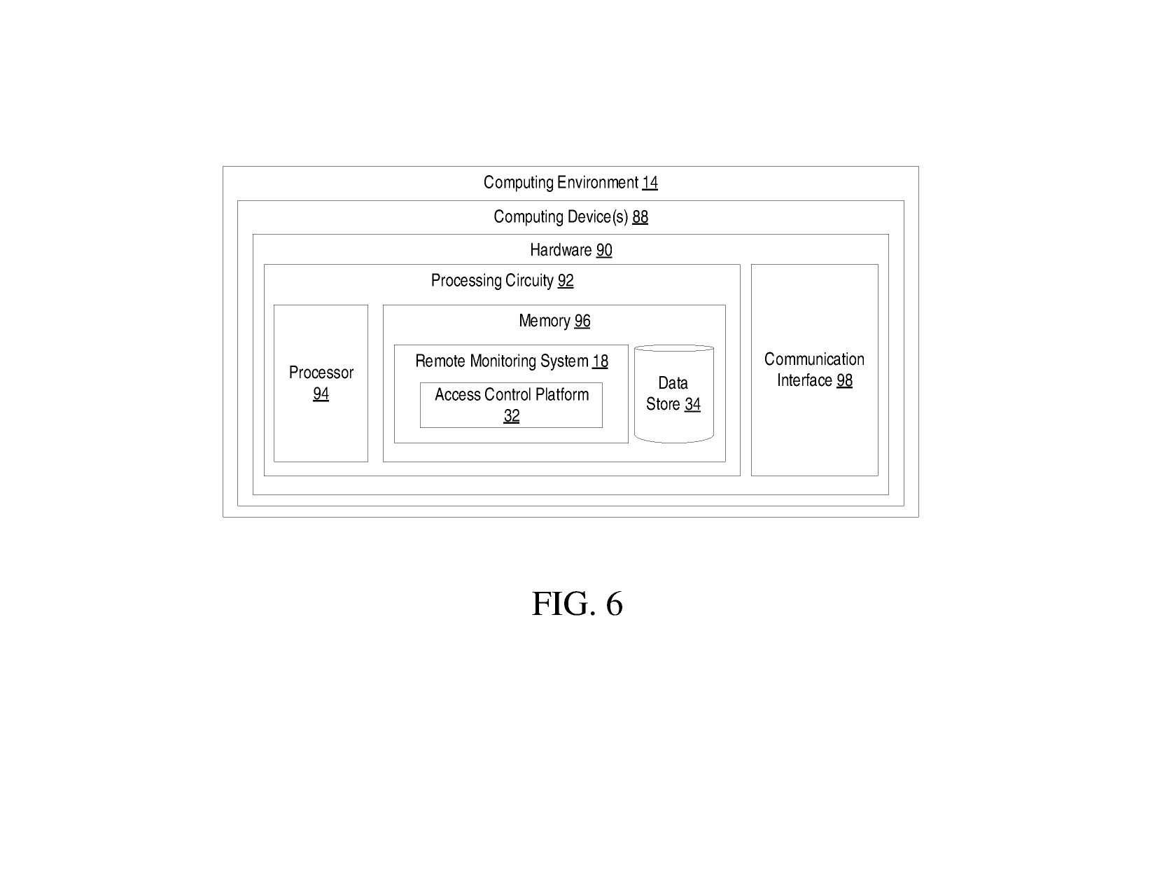

Referring now to FIG. 5, there is shown a block diagram illustrating an example mobile device 28 according to various embodiments of the present disclosure. As shown, control device 22 comprises hardware 76. The hardware 76 may include processing circuitry 78. The processing circuitry 78 may include one or more processors 80 and one or more memories 82. Each processor 80 may include and/or be associated with one or more central processing units, data buses, buffers, and interfaces to facilitate operation. In addition to or instead of a processor 80 and memory 82, the processing circuitry 78 may comprise other types of integrated circuitry that perform various functionality. Integrated circuitry may include one or more processors 80, processor cores, FPGAs, ASICs, GPUs, SoCs, or other components configured to execute instructions. The processor 80 may be configured to access (e.g., write to and/or read from) the memory 82, which may comprise any kind of volatile and/or nonvolatile memory, e.g., cache, buffer memory, RAM, ROM, optical memory, and/or EPROM. Further, memory 82 may be embodied in the form of one or more storage devices. The processing circuitry 78 may be configured to perform various functionality described herein. For example, computer instructions may be stored in memory 82 and/or another computer-readable medium that, when executed by processor 80, causes the processor 80 to perform various functionality described herein.

Hardware 76 may include communication interface 84 facilitating communication between mobile device 28 and one or more elements in system 10. For example, communication interface 84 may be configured for establishing and maintaining at least a wireless or wired connection with one or more elements of system 10 such as computing environment 14.

Mobile device 28 further has software 86 (which may include one or more software applications) stored internally in, for example, memory 82, or stored in external memory (e.g., database, storage array, network storage devices, etc.) accessible by the mobile device 28 via an external connection. Software 86 may include any software or program that configures processing circuitry 78 to perform the steps or processes of the present disclosure.

The processing circuitry 78 may be configured to control any of the methods and/or processes described herein and/or to cause such methods, and/or processes to be performed, e.g., by mobile device 28. Processor 80 corresponds to one or more processors 80 for performing mobile device 28 functions described herein. The memory 82 is configured to store data and/or files and/or other information/data. In some embodiments, the software 86 may include instructions that, when executed by the processor 80 and/or processing circuitry 78, cause the processor 80 and/or processing circuitry 78 to perform the processes described herein with respect to the mobile device 28. Accordingly, by having computer instructions stored in memory 82 accessible to the processor 80, the processor 80 may be configured to perform the actions described herein.

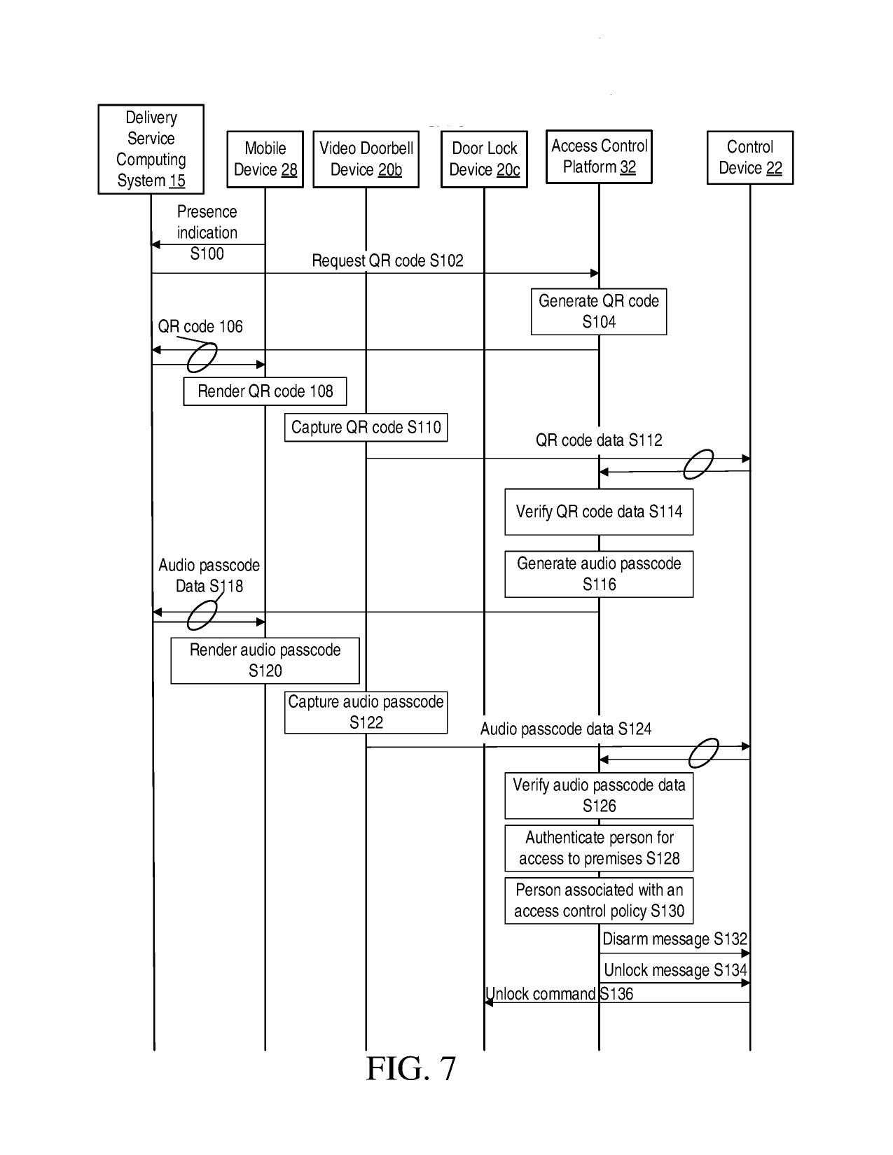

FIG. 6 is a block diagram illustrating the example computing environment 14 according to various embodiments. As shown, the computing environment 14 may include one or more computing devices 88. In embodiments using multiple computing devices 88, the computing devices 88 may be located in a single installation or may be distributed among many different geographic locations. As shown, each computing device 88 comprises hardware 90. The hardware 90 may include processing circuitry 92. The processing circuitry 92 may include one or more processors 94 and one or more memories 96. Each processor 94 may include and/or be associated with one or more central processing units, data buses, buffers, and interfaces to facilitate operation. In addition to or instead of a processor 94 and memory 96, the processing circuitry 92 may comprise other types of integrated circuitry that perform various functionality. Integrated circuitry may include one or more processors 94, processor cores, FPGAs, ASICs, GPUs, SoCs, or other components configured to execute instructions. The processor 94 may be configured to access (e.g., write to and/or read from) the memory 96, which may comprise any kind of volatile and/or nonvolatile memory, e.g., cache, buffer memory, RAM, ROM, optical memory, and/or EPROM. Further, memory 96 may be embodied in the form of one or more storage devices. The processing circuitry 92 may be configured to perform various functionality described herein. For example, computer instructions may be stored in memory 96 and/or another computer-readable medium that, when executed by processor 94, causes the processor 94 to perform various functionality.

Hardware 90 may include communication interface 98 facilitating communication between one or more elements in system 10. For example, communication interface 98 may be configured for establishing and maintaining at least a wireless or wired connection with one or more elements of system 10 such as control devices 22, premises devices 20, mobile device 28 etc.

The processing circuitry 92 may be configured to control any of the methods and/or processes described herein and/or to cause such methods, and/or processes to be performed, e.g., in computing environment 14. Processor 94 corresponds to one or more processors 94 for performing computing device 88 functions described herein.

The memory 96 is configured to store data, such as files, remote monitoring system data, and/or other information/data. Also stored in the memory 96 and executable by the processor 94 are the remote monitoring system 18 and access control platform 32. Although FIG. 6 shows the remote monitoring system 18 and access control platform 32 being in a single computing device 88, the remote monitoring system 18 and access control platform 32 may execute in multiple computing devices 88 of the computing environment 14. To perform the functionality of the remote monitoring system 18 and access control platform 32, the memory 96 may include instructions that, when executed by the processor 94 and/or processing circuitry 92, causes the computing device 88 to perform the functionality performed by the remote monitoring system 18 and access control platform 32 described herein.

In one or more embodiments, delivery service computing system 15 may comprise the same or similar components as computing environment 14 except that the functionalities of the components of the delivery service computing system 15 are configured to perform delivery service computing system 15 functions described herein.

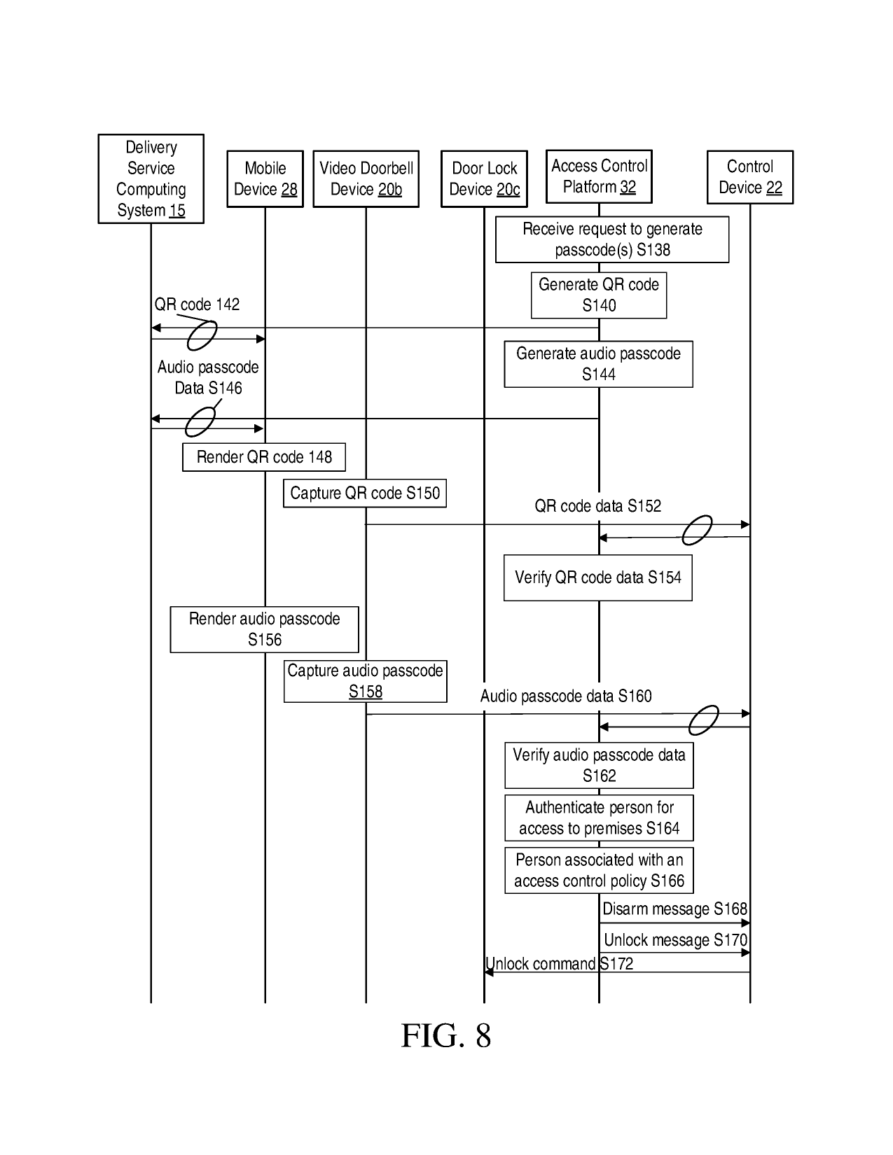

FIG. 7 is a signaling diagram showing an example of functionality involving components of the system 10 of FIG. 2 according to various embodiments. In particular, the diagram of FIG. 7 depicts an example of functionality that may occur when a delivery person with a mobile device 28 arrives at a premises 17 for the purpose of leaving a delivery item within the premises 17. Beginning at step S100, when the delivery person is present at the premises 17, the mobile device 28 transmits a presence indication to the delivery service computing system 15 indicating that the delivery person associated with mobile device 28 is located at the premises 17. For example, mobile device 28 may have a software application operating in mobile device 28 that automatically triggers the presence indication when mobile device 28 is proximate premises 17 such as based on, for example, geo-fencing, a global positioning system (GPS), etc. Alternatively, the delivery person associated with mobile device 28 may manually trigger the software application to cause mobile device 28 to transmit the presence indication.

The delivery service computing system 15 receives the presence indication and, in response to the presence indication and transmits to the access control platform a request for a QR code 26 (e.g., optically capturable passcode 26) (Step S102).

Then, at step S104, in response to the request for QR code 26, access control platform 32 generates a QR code 26 and transmits the QR code 26 to delivery service computing system 15 for forwarding to mobile device 28 (Steps S104-S106).

Alternatively, instead of transmitting QR code 26, access control platform 32 transmits QR code 26 information that is usable for retrieving the actual QR code 26. For example, the QR code 26 information may comprise a uniform resource locator (URL) to a webpage where The person associated with mobile device 28 receives the QR code 26 information in a message (e.g., Short Message Service (SMS) message) via mobile device 28. The person then selects the URL on the mobile device 28, causing a web browser to open and load the webpage on the mobile device 28. The webpage may comprise terms and conditions for the person to review and accept. The webpage can further comprise instructions for the person on how to gain access to premises 17. After the person accepts the terms and conditions, access control platform 32 generates a QR code 26 and embeds it in the webpage that is rendered in the web browser on mobile device 28. The person can save the QR code 26 by adding it to the mobile device 28’s digital wallet or saving the QR code 26 in the mobile device 28’s memory.

At step S108, the mobile device 28 renders the QR code 26 on its display 30. Then, at step S110, video doorbell device 20b captures an image and/or video of the QR code 26 as it is rendered on the display 30 of the mobile device 28. For example, the delivery person at premises 17 may hold the mobile device 28 in front of the video doorbell device 20b so that the video doorbell device 20b can capture an image and/or video of the displayed QR code 26. At step S112, the video doorbell device 20b transmits captured QR code 26 data (e.g., image and/or video of the QR code 26) to the control device 22 for transmission to access control platform 32 for verification of the QR code 26. In one or more other embodiments, the QR code 26 may be verified locally by control device 22, the device that captured the QR code 26 (e.g., video doorbell device 20b), or another entity of the premises monitoring system 12, without transmitting the QR code 26 data to the access control platform 32 for remote verification.

At step S114, the access control platform 32 receives and verifies the captured QR code 26 data (e.g., the image and/or video of the QR code 26). For example, access control platform 32 may verify the captured QR code 26 by comparing the received QR code 26 to the QR code 26 generated at step S104 and determining that the received QR code 26 is consistent with the generated QR code 26.

In response to verifying the received QR code 26, the access control platform 32 generates an audio passcode 24 (Step S116). In one or more embodiments, the audio passcode 24 is a random sound signature (e.g., randomly generated sound signature) of alpha and/or numeric characters or a random sound signature of one or more capturable frequencies. For example, the random sound signature may be based on the capability of the premises monitoring system 12 such that access control platform 32 may generate an inaudible random sound signature (e.g., ultrasonic-based signature) instead of an audible random sound signature (e.g., alpha and/or numeric based sound signature), since the premise monitoring system 12 may be capable of detecting ultrasonic sounds and/or frequencies. At step S118, the access control platform 32 then indicates or communicates audio passcode 24 data to mobile device 28.

As shown at step S120, the mobile device 28 then renders the audio passcode via speaker 31. In one or more embodiments, after transmitting the audio passcode 24 data, access control platform 32 transmits a message to control device 22 or video doorbell device 20b to cause video doorbell device 20b play an audible message prompting the delivery person to position the mobile device 28 near the video doorbell device 20b so that the microphone 70 of the video doorbell device 20b will be in audible range of the mobile device 28 when the mobile device 28 renders the audio passcode 24. As an example, the video doorbell device 20b may play an audible message that states, “Please hold your handheld delivery personnel device approximately one foot away from the doorbell.” Then, at step S122, video doorbell device 20b captures the audio passcode 24 via microphone 70. For example, in response to receiving the passcode prompt, video doorbell device 20b records audio using microphone 64 to capture audio passcode 24. At step S124, video doorbell device 20 then transmits the audio passcode 24 data (e.g., recorded audio comprising audio passcode 24) to control device 22 for transmission to access control platform 32 for verification.

Access control platform 32 then receives and verifies the recorded audio passcode 24 data (Step S126). To verify the audio passcode 24, access control platform 32 may, for example, compare the received audio passcode 24 with the audio passcode 24 generated at step S116 and stored in data store 34. If the received audio passcode 24 is consistent with the previously generated audio passcode 24, then the access control platform 23 may determine that the received audio passcode 24 is verified. In one or more embodiments, video doorbell device 20b, control device 22, and/or other devices associated with premises monitoring system 12 verify the audio passcode 24 using the audio recording.

In response to verifying the recorded audio passcode 24, access control platform 32 deems the person associated with mobile device 28 authenticated (Step S128). At step S130, in response to the person being deemed authenticated, the access control platform 32 determines that the person is allowed access to the premises 17 based on at least one access policy. For example, access control platform 32 may determine whether the person is associated with one or more access policies and whether at least one condition of the access policies is met. For example, an access policy may define that the authenticated person is allowed access to the premises at a specific time and date (e.g., time-based access) or in response to a detected event (e.g., event-based access such as a delivery event). Hence, access control platform 32 may determine the type of access the person is allowed and whether one or more access policies (e.g., access policies based on time, event, alarm, etc.) are satisfied.

At steps S132-S136, in response to determining that the person is allowed access to the premises according to an access policy, the access control platform 32 causes the premises monitoring system 12 to disarm and causes at least one lock for a door of the premises to unlock. For example, if access control platform 32 determines that one or more access policies are satisfied, access control platform 32 may transmit one or more commands (e.g., access command(s)) to premises monitoring system 12 that cause premises monitoring system 12 to disarm and that cause at least one door lock device 20c (e.g., an electronic door lock) to unlock.

Further, in various embodiments, access control platform 32 may be configured to determine that the person has left the premises 17. For example, after the authenticated person has accessed the premises 17, access control platform 32 may subsequently determine that the person has left the premises 17 based on, for example, a detection, via a premises device 20, that the authenticated person is walking away from premises 17. In some examples, other sensor data from one or more premises device 20 may be used by access control platform 32 to determine whether the authenticated person has left the premises 17. In response to determining that the person has left the premises 17, access control platform 32 may cause the lock (e.g., door lock device 20c) to transition from an unlocked state to a locked state and cause the premises monitoring system 12 to transition from a disarmed state to an armed state.

Further, access control platform 32 and/or premises monitoring system 12 may maintain a timestamped log entry for each time a person enters the premises 17 using one of the types of access as described herein. The log can be reviewed periodically, and permissions (e.g., types of access) can be dynamically modified.

In one or more embodiments, different devices can be used to capture the QR code 26 and/or the audio passcode 24. For example, instead of video doorbell device 20b, another type of premises device 20 with a camera can be used to capture the QR code 26. Additionally, any premises device 20 with a microphone can be used to capture the audio passcode 24. For example, if door lock device 20c has a microphone, door lock device 20c can be used to capture the audio passcode 24. The device that captures the QR code 26 can be the same or different from the device that captures the audio passcode 24 in various embodiments.

In one or more embodiments, the order of one or more steps that are described with respect to FIG. 7 may change. For example, audio passcode 24 may be generated and transmitted to mobile device 28 before the QR code data is verified. In another example, delivery service computing system 15 may request audio passcode 24 instead of QR code 26 such that the audio passcode 24 is generated before the QR code 26. Further, the order and timing in which mobile device 28 receives QR code 26 and audio passcode 24 may be different from the example of FIG. 7, but access control platform 32 is still configured to verify both the QR code 26 and audio passcode 24 as described herein.

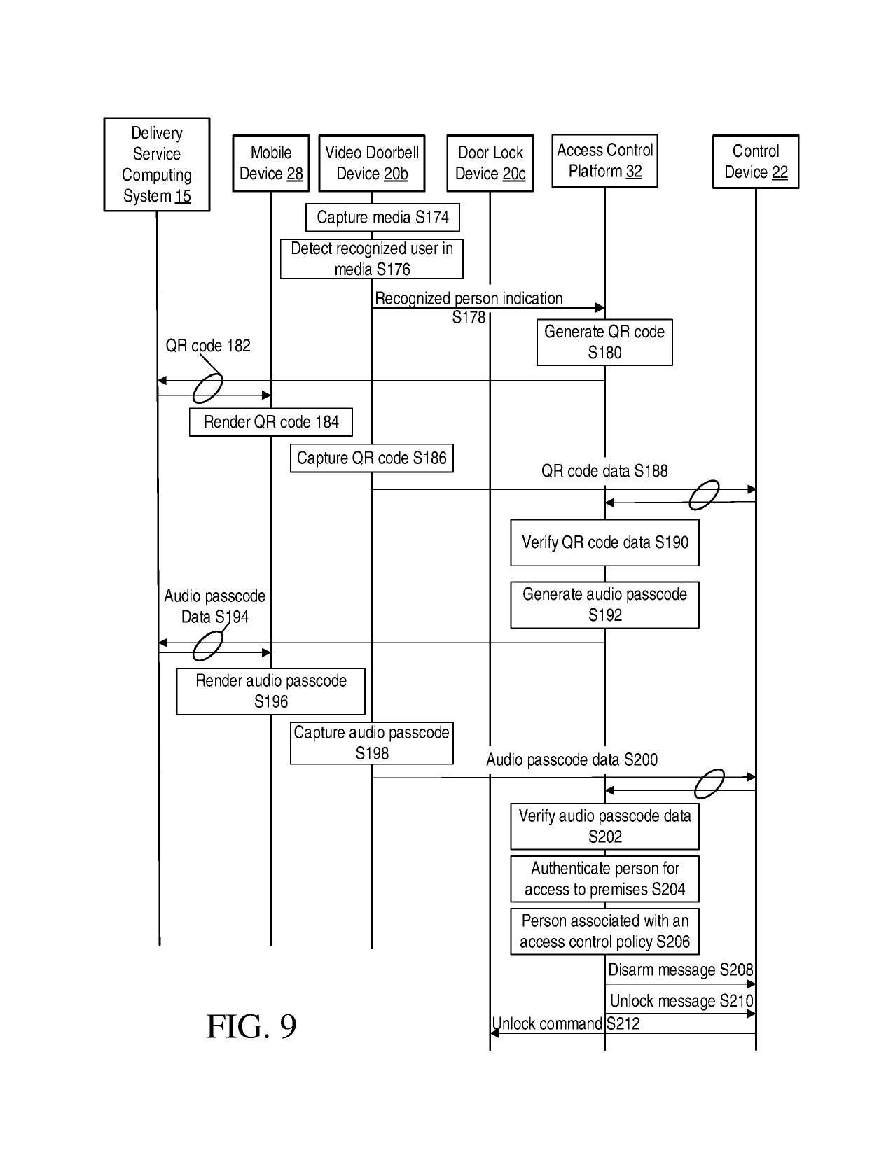

FIG. 8 is a signaling diagram showing another example of functionality involving the system 10 of FIG. 2 according to various embodiments. In particular, FIG. 8 depicts an example of functionality that may occur when a registered user of the premises monitoring system 12, such as someone who resides at the premises 17, uses a computing device (not shown), such as a smart phone or personal computer, to request the access control platform 23 to generate a QR code 26 and audio passcode 24 for another person to use to gain access to the premises 17. Beginning at step S138, the access control platform 32 receives a request to generate passcodes (e.g., QR code 26 and audio passcode 24). Access control platform 32, in response to the request, generates a QR code 26 and transmits the QR code 26 to delivery service computing system 15 for forwarding to mobile device 28 (Steps S140-S142).

In response to the request or the transmission of the QR code 26, the access control platform 32 generates an audio passcode 24 (Step S144). In one or more embodiments, the audio passcode 24 is a random sound signature (e.g., randomly generated sound signature) of alpha and/or numeric characters or a random sound signature of one or more capturable frequencies. For example, the random sound signature may be based on the capability of the premises monitoring system 12 such that access control platform 32 may generate an inaudible random sound signature (e.g., ultrasonic-based signature) instead of an audible random sound signature (e.g., alpha and/or numeric based sound signature), since the premise monitoring system 12 may be capable of detecting ultrasonic sounds and/or frequencies. At step S146, the access control platform 32 then indicates or communicates audio passcode 24 data to mobile device 28.

At step S148, the mobile device 28 renders the QR code 26 on its display 30. Then, at step S150, video doorbell device 20b captures an image and/or video of the QR code 26 as it is rendered on the display 30 of the mobile device 28. For example, the delivery person at premises 17 may hold the mobile device 28 in front of the video doorbell device 20b so that the video doorbell device 20b can capture an image and/or video of the displayed QR code 26. At step S152, the video doorbell device 20b transmits captured QR code 26 data (e.g., image and/or video of the QR code 26) to the control device 22 for transmission to access control platform 32 for verification of the QR code 26. In one or more other embodiments, the QR code 26 may be verified locally by control device 22, the device that captured the QR code 26 (e.g., video doorbell device 20b), or another entity of the premises monitoring system 12, without transmitting the QR code 26 data to the access control platform 32 for remote verification.

At step S154, the access control platform 32 receives and verifies the captured QR code 26 data (e.g., the image and/or video of the QR code 26). For example, access control platform 32 may verify the captured QR code 26 by comparing the received QR code 26 to the QR code 26 generated at S140 and determining that the received QR code 26 is consistent with the generated QR code 26.

As shown at step S156, the mobile device 28 then renders the audio passcode via speaker 31. In one or more embodiments, after transmitting the audio passcode 24 data, access control platform 32 transmits a message to control device 22 or video doorbell device 20b to cause video doorbell device 20b play an audible message prompting the delivery person to position the mobile device 28 near the video doorbell device 20b so that the microphone 70 of the video doorbell device 20b will be in audible range of the mobile device 28 when the mobile device 28 renders the audio passcode 24. As an example, the video doorbell device 20b may play an audible message that states, “Please hold your handheld delivery personnel device approximately one foot away from the doorbell.” Then, at step S158, video doorbell device 20b captures the audio passcode 24 via microphone 70. For example, in response to receiving the passcode prompt, video doorbell device 20b records audio using microphone 64 to capture audio passcode 24. Video doorbell device 20 then transmits the audio passcode 24 data (e.g., recorded audio comprising audio passcode 24) to control device 22 for transmission to access control platform 32 for verification (Step S160).

Access control platform 32 then receives and verifies the recorded audio passcode 24 data (Step S162). To verify the audio passcode 24, access control platform 32 may, for example, compare the received audio passcode 24 with the audio passcode 24 generated at step S144 and stored in data store 34. If the received audio passcode 24 is consistent with the previously generated audio passcode 24, then the access control platform 23 may determine that the received audio passcode 24 is verified. In one or more embodiments, video doorbell device 20b, control device 22, and/or other devices associated with premises monitoring system 12 verifies the audio passcode 24 using the audio recording.

In response to verifying the recorded audio passcode 24, access control platform 32 deems the person associated with mobile device 28 authenticated (Step S164). At step S166, in response to the person being deemed authenticated, the access control platform 32 determines that the person is allowed access to the premises 17 based on at least one access policy. For example, access control platform 32 may determine whether the person is associated with one or more access policies and whether at least one condition of the access policies is met. For example, an access policy may define that the authenticated person is allowed access to the premises at a specific time and date (e.g., time-based access) or in response to a detected event (e.g., event-based access such as a delivery event). Hence, access control platform 32 may determine the type of access the person is allowed and whether one or more access policies (e.g., access policies based on time, event, alarm, etc.) are satisfied.

At steps S168-S172, in response to determining that the person is allowed access to the premises according to an access policy, the access control platform 32 causes the premises monitoring system 12 to disarm and causes at least one lock for a door of the premises to unlock. For example, if access control platform 32 determines that one or more access policies are satisfied, access control platform 32 may transmit one or more commands (e.g., access command(s)) to premises monitoring system 12 that cause premises monitoring system 12 to disarm and that cause at least one door lock device 20c (e.g., an electronic door lock) to unlock.

Further, in various embodiments, access control platform 32 may be configured to determine that the person has left the premises 17. For example, after the authenticated person has accessed the premises 17, access control platform 32 may determine that the person has left the premises 17 based on, for example, a detection, via a premises device 20, that the authenticated person is walking away from premises 17. In some examples, other sensor data from one or more premises devices 20 may be used by access control platform 32 to determine whether the authenticated person has left the premises 17. In response to determining that the person has left the premises 17, access control platform 32 may cause the lock (e.g., door lock device 20c) to transition from an unlocked state to a locked state and cause the premises monitoring system 12 to transition from a disarmed state to an armed state.

Further, access control platform 32 and/or premises monitoring system 12 may maintain a timestamped log entry for each time a person enters the premises 17 using one of the types of access as described herein. The log can be reviewed periodically, and permissions (e.g., types of access) can be dynamically modified.

In one or more embodiments, different devices can be used to capture the QR code 26 and/or the audio passcode 24. For example, instead of video doorbell device 20b, another type of premises device 20 with a camera can be used to capture the QR code 26. Additionally, any premises device 20 with a microphone can be used to capture the audio passcode 24. For example, if door lock device 20c has a microphone, door lock device 20c can be used to capture the audio passcode 24. The device that captures the QR code 26 can be the same or different from the device that captures the audio passcode 24 in various embodiments.

In one or more embodiments, the order of one or more steps that are described with respect to FIG. 8 may change. For example, audio passcode 24 may be rendered before the QR code 26 is rendered. Further, the order and timing in which mobile device 28 receives QR code 26 and audio passcode 24 may be different from the example of FIG. 8 but access control platform 32 is still configured to verify both the QR code 26 and audio passcode 24 as described herein.

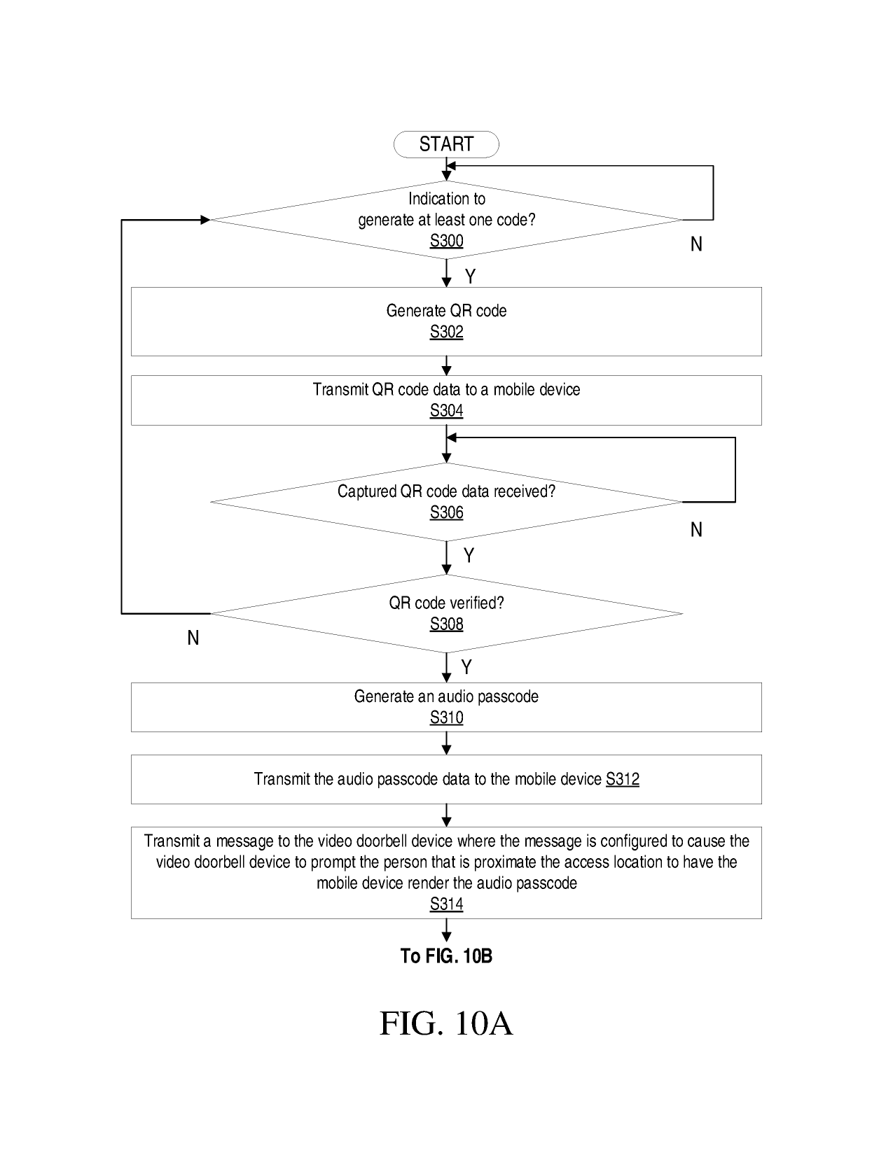

FIG. 9 is a signaling diagram showing another example of functionality involving components of the system 10 of FIG. 2. In particular, FIG. 9 shows an example of functionality that may occur when the video doorbell device 20b detects a person that corresponds to a registered user of the premises monitoring system 12 and, in response to detecting the person, initiates a process of the access control platform 32 generating a QR code 26 and audio passcode 24 for the person to use to gain access to the premises 17.

Beginning at step S174, the video doorbell device 20b captures media, such as one or more images and/or video. Video doorbell device 20b then detects a recognized person in the media (Step S176). For example, video doorbell device 20b may perform facial recognition on the captured media to determine whether a detected person is a recognized person, i.e., a person that is registered with premises monitoring system 12 for access to premises 17. If a recognized person is detected in the media, video doorbell device 20b transmits a recognized person indication to the access control platform 32 (Step S178). In response to the recognized person indication,

Then, in response to the recognized person indication, access control platform 32 generates a QR code 26 and transmits the QR code 26 to delivery service computing system 15 for forwarding to mobile device 28 (Steps S180-S182).

Alternatively, instead of transmitting QR code 26, access control platform 32 transmits QR code 26 information that is usable for retrieving QR code 26. For example, the QR code 26 information may comprise a uniform resource locator (URL) to a webpage where the person associated with mobile device 28 receives the QR code 26 information in a message (e.g., Short Message Service (SMS) message) via mobile device 28. The person then selects the URL on the mobile device 28, causing a web browser to open and load the webpage on the mobile device 28. The webpage may comprise terms and conditions for the person to review and accept. The webpage can further comprise instructions for the person on how to gain access to premises 17. After the person accepts the terms and conditions, access control platform 32 generates a QR code 26 and embeds it in the webpage that is rendered in the web browser on mobile device 28. The person can save the QR code 26 by adding it to the mobile device 28’s digital wallet or saving the QR code 26 in the mobile device 28’s memory.

At step S184, the mobile device 28 renders the QR code 26 on its display 30. Then, at step S186, video doorbell device 20b captures an image and/or video of the QR code 26 as it is rendered on the display 30 of the mobile device 28. For example, the delivery person at premises 17 may hold the mobile device 28 in front of the video doorbell device 20b so that the video doorbell device 20b can capture an image and/or video of the displayed QR code 26. At step S188, the video doorbell device 20b transmits captured QR code 26 data (e.g., image and/or video of the QR code 26) to the control device 22 for transmission to access control platform 32 for verification of the QR code 26. In one or more other embodiments, the QR code 26 may be verified locally by control device 22, the device that captured the QR code 26 (e.g., video doorbell device 20b), or another entity of the premises monitoring system 12, without transmitting the QR code 26 data to the access control platform 32 for remote verification.

At step S190, the access control platform 32 receives and verifies the captured QR code 26 data (e.g., the image and/or video of the QR code 26). For example, access control platform 32 may verify the captured QR code 26 by comparing the received QR code 26 to the QR code 26 generated at step S180 and determining that the received QR code 26 is consistent with the generated QR code 26.

In response to verifying the received QR code 26, the access control platform 32 generates an audio passcode 24 (Step S192). In one or more embodiments, the audio passcode 24 is a random sound signature (e.g., randomly generated sound signature) of alpha and/or numeric characters or a random sound signature of one or more capturable frequencies. For example, the random sound signature may be based on the capability of the premises monitoring system 12 such that access control platform 32 may generate an inaudible random sound signature (e.g., ultrasonic-based signature) instead of an audible random sound signature (e.g., alpha and/or numeric based sound signature), since the premise monitoring system 12 may be capable of detecting ultrasonic sounds and/or frequencies. At step S194, the access control platform 32 then indicates or communicates audio passcode 24 data to mobile device 28.

As shown at step S196, the mobile device 28 then renders the audio passcode via speaker 31. In one or more embodiments, after transmitting the audio passcode 24 data, access control platform 32 transmits a message to control device 22 or video doorbell device 20b to cause video doorbell device 20b play an audible message prompting the delivery person to position the mobile device 28 near the video doorbell device 20b so that the microphone 70 of the video doorbell device 20b will be in audible range of the mobile device 28 when the mobile device 28 renders the audio passcode 24. As an example, the video doorbell device 20b may play an audible message that states, “Please hold your handheld delivery personnel device approximately one foot away from the doorbell.” Then, at step S198, video doorbell device 20b captures the audio passcode 24 via microphone 70. For example, in response to receiving the passcode prompt, video doorbell device 20b records audio using microphone 64 to capture audio passcode 24. Video doorbell device 20 then transmits the audio passcode 24 data (e.g., recorded audio comprising audio passcode 24) to control device 22 for transmission to access control platform 32 for verification (Step S200).

Access control platform 32 then receives and verifies the recorded audio passcode 24 data (Step S202). To verify the audio passcode 24, access control platform 32 may, for example, compare the received audio passcode 24 with the audio passcode 24 generated at step S192 and stored in data store 34. If the received audio passcode 24 is consistent with the previously generated audio passcode 24, then the access control platform 23 may determine that the received audio passcode 24 is verified. In one or more embodiments, video doorbell device 20b, control device 22, and/or other devices associated with premises monitoring system 12 verifies the audio passcode 24 using the audio recording.

In response to verifying the recorded audio passcode 24, access control platform 32 deems the person associated with mobile device 28 authenticated (Step S204). At step S206, in response to the person being deemed authenticated, the access control platform 32 determines that the person is allowed access to the premises 17 based on at least one access policy. For example, access control platform 32 may determine whether the person is associated with one or more access policies and whether at least one condition of the access policies is met. For example, an access policy may define that the authenticated person is allowed access to the premises at a specific time and date (e.g., time-based access) or in response to a detected event (e.g., event-based access such as a delivery event). Hence, access control platform 32 may determine the type of access the person is allowed and whether one or more access policies (e.g., access policies based on time, event, alarm, etc.) are satisfied.

At steps S208-S212, in response to determining that the person is allowed access to the premises according to an access policy, the access control platform 32 causes the premises monitoring system 12 to disarm and causes at least one lock for a door of the premises to unlock. For example, if access control platform 32 determines that one or more access policies are satisfied, access control platform 32 may transmit one or more commands (e.g., access command(s)) to premises monitoring system 12 that cause premises monitoring system 12 to disarm and that cause at least one door lock device 20c (e.g., an electronic door lock) to unlock.

Further, in various embodiments, access control platform 32 may be configured to determine that the person has left the premises 17. For example, after the authenticated person has accessed the premises 17, access control platform 32 may determine that the person has left the premises 17 based on, for example, a detection, via a premises device 20, that the authenticated person is walking away from premises 17. In some examples, other sensor data from one or more premises device 20 may be used by access control platform 32 to determine whether the authenticated person has left the premises 17. In response to determining that the person has left the premises 17, access control platform 32 may cause the lock (e.g., door lock device 20c) to transition from an unlocked state to a locked state and cause the premises monitoring system 12 to transition from a disarmed state to an armed state.

Further, access control platform 32 and/or premises monitoring system 12 may maintain a timestamped log entry for each time a person enters the premises 17 using one of the types of access as described herein. The log can be reviewed periodically, and permissions (e.g., types of access) can be dynamically modified.

In one or more embodiments, different devices can be used to capture the QR code 26 and/or the audio passcode 24. For example, instead of video doorbell device 20b, another type of premises device 20 with a camera can be used to capture the QR code 26. Additionally, any premises device 20 with a microphone can be used to capture the audio passcode 24. For example, if door lock device 20c has a microphone, door lock device 20c can be used to capture the audio passcode 24. The device that captures the QR code 26 can be the same or different from the device that captures the audio passcode 24 in various embodiments.

In one or more embodiments, the order of one or more steps that are described with respect to FIG. 9 may change. For example, audio passcode 24 may be generated and transmitted to mobile device 28 before the QR code data is verified. Further, the order and timing in which mobile device 28 receives QR code 26 and audio passcode 24 may be different from the example of FIG. 9, but access control platform 32 is still configured to verify both the QR code 26 and audio passcode 24 as described herein.

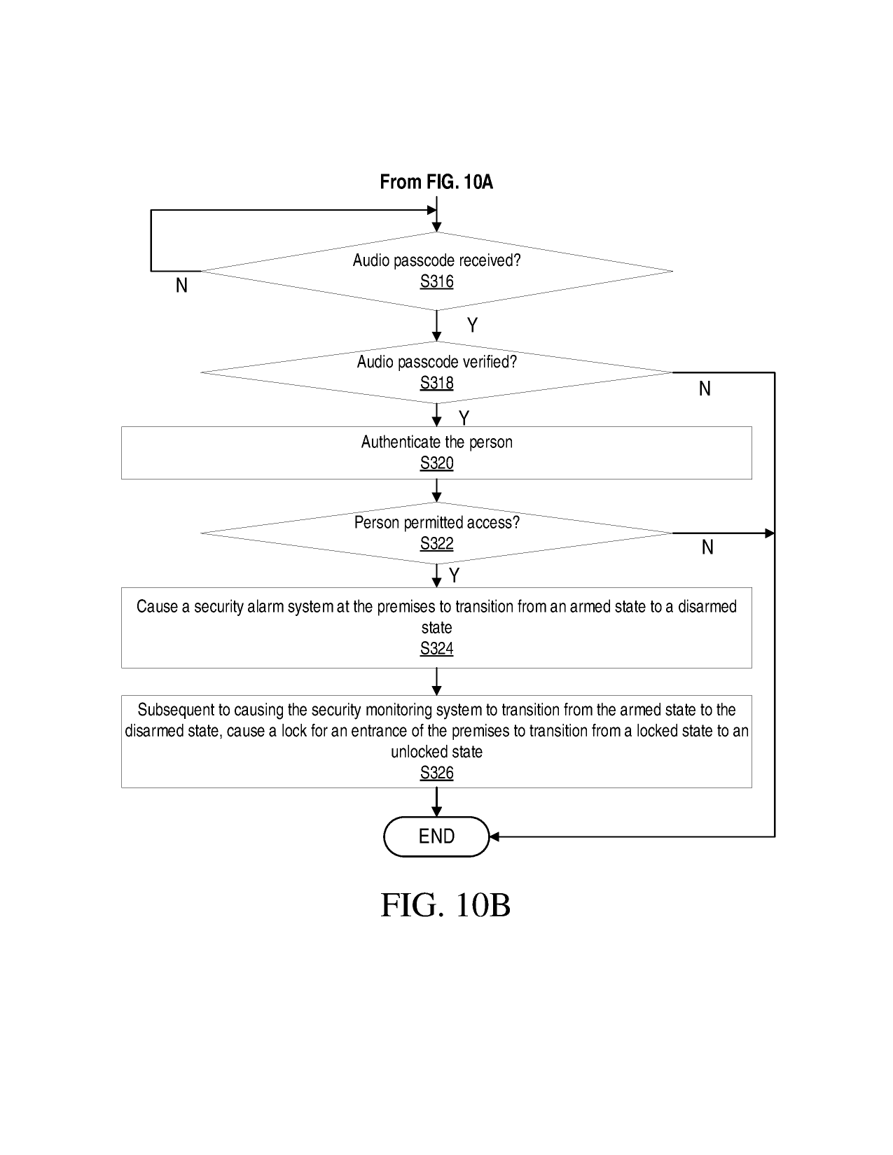

FIGS. 10A-10B is a flowchart of an example process performed by the access control platform 32 according to various embodiments. Beginning at block S300, at the access control platform 32 determines whether it has received an indication to generate at least one code. For example, the indication may correspond to a request for a QR code 26 (step S102), a request to generate at least one passcode (step S138), a recognized person indication (step S178), among other indications that can used to initiate the authentication process. If an indication has not been received, the process may repeat block S300. If an indication has been received, the access control platform 32 generates a QR code 26, as described herein, such as with respect to step S104 (Block S302). The access control platform 33 then transmits QR code data to mobile device 28, as described herein, such as with respect to step S106 (Block S304).

At block S306, the access control platform 32 determines whether it has received captured QR code data. If captured QR code data has not been received, the access control platform 32 may repeat block S306. If the access control platform 32 receives captured QR code data, the access control platform 32 verifies the captured QR code (Block S308). If the QR code fails verification, the process may, for example, the process returns to block S300 or the process may end. If the QR code passes verification (i.e., the QR code is verified), the access control platform 32 generates an audio passcode 24, as described herein such as with respect to step S116 (Block S310).

At block S312, the access control platform 32 then transmits the audio passcode 24 to mobile device 28 as described herein, such as with respect to step S118 (Block S312). Then, at block S312, the access control platform 32 transmits a message to the video doorbell device 20b to cause the video doorbell device 20b to prompt the delivery person to cause the mobile device 28 to render the audio passcode 24, as described herein (Block S314).

At block S316, the access control platform 32 then determines whether an audio passcode 24 has been received. If the audio passcode has not been received, the process may repeat block S316 for a predefined period of time, or may end. At block S318, if the audio passcode 24 has been received, the process continues, and the access control platform 32 determines whether the audio passcode 24 has been verified. For example, the access control platform 32 may verify that the received audio passcode 24 corresponds to the audio passcode 24 generated at step S116, as described herein.

At block S320, the access control platform 32, in response to verification of the received audio passcode 24, authenticates the person, as described herein. At block S322, the access control platform 32 determines whether the authenticated person (e.g., the delivery person) is permitted access to the premises 17 according to an access policy, as described herein. If the authenticated person is not permitted access to premises 17, the process may end or return to block S300. For example, while the person was authenticated, the person may be associated with an access policy that allows for access during a specific period of time, during a specific event, etc. (e.g., one or more of time-based access, alarm-based access, event-based access or guest-based access), such that the person may not be allowed access at the particular time.

At block S324, if the access control platform 32 determines that the person is permitted access to the premises 17 according to the access policy, the access control platform 32 then causes a premises monitoring system 12 at the premises 17 to transition from an armed state to a disarmed state, as described herein. At block S326, the access control platform 32, subsequent to causing the premises monitoring system 12 to transition from the armed state to the disarmed state, causes a lock for an entrance of the premises 17 to transition from a locked state to an unlocked state, as described herein.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects. Any process, step, action and/or functionality described herein may be performed by, and/or associated to, a corresponding module and/or unit, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the "C" programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

1. A system, comprising:
at least one computing device comprising:
at least one processor; and
at least one memory storing a plurality of instructions that, when executed by the at least one processor, cause the at least one processor to:
receive an image of an optically capturable passcode, the image being captured by a premises monitoring system;
receive recorded audio of audio rendered by a mobile device and captured by the premises monitoring system, the audio rendered by the mobile device comprising an audio passcode;
authenticate a person associated with the mobile device based on the optically capturable passcode and the audio passcode;
determine that the person is permitted access to a premises according to an access policy; and
in response to authenticating the person and determining that the person is permitted access to the premises, cause a lock securing an access point of the premises to unlock.

2. The system of claim 1, wherein the audio passcode is a randomly generated sound signature that is generated by the at least one computing device.

3. The system of claim 1, wherein the optically capturable passcode comprises a quick response (QR) code that is downloadable to the mobile device associated with the person.

4. The system of claim 1, wherein the instructions are further configured to cause the at least one computing device to:
receive an indication that the person is present at the premises ;
in response to the indication, generate the optically capturable passcode;
transmit the optically capturable passcode to the mobile device;
after transmitting the optically capturable passcode to the mobile device, generate the audio passcode; and
transmit the audio passcode to the mobile device.

5. The system of claim 4, wherein the instructions are further configured to cause the at least one computing device to:
determine that the recorded audio corresponds to the generated audible passcode; and
in response to determining that the recorded audio corresponds to the generated audible passcode, deem the person authenticated.

6. The system of claim 5, wherein the instructions are further configured to cause the at least one computing device to, in response to deeming the person authenticated and determining that the person is permitted access to the premises, cause a security alarm system at the premises to transition from an armed state to a disarmed state.

7. The system of claim 4, wherein the indication that the person is present at the premises corresponds to a message initiated by the person.

8. The system of claim 6, wherein the indication corresponds to an alert indicating that a recognized person has been detected at the premises.

9. The system of claim 1, wherein the instructions are further configured to cause the at least one computing device to:
determine that the optically capturable passcode in the image corresponds to the generated optically capturable passcode; and
in response to determining that the optically capturable passcode in the image corresponds to the generated optically capturable passcode, transmit a message to a premises device of the premises monitoring system, the message being configured to cause the premises device to prompt the person to cause the mobile device to render the audio passcode.

10. The system of claim 1, wherein a premises device of the premises monitoring system is configured to capture the optically capturable passcode and the audio passcode, the premises device is a video doorbell device that is proximate an access location of a premises.

11. The system of claim 1, wherein the audio passcode comprises an inaudible sound signature.

12. A method, comprising:
receiving an image of an optically capturable passcode, the image being captured by a premises monitoring system;
receiving recorded audio of audio rendered by a mobile device and captured by the premises monitoring system, the audio rendered by the mobile device comprising an audio passcode;
authenticating a person associated with the mobile device based on the optically capturable passcode and the audio passcode;
determining that the person is permitted access to a premises according to an access policy; and
in response to authenticating the person and determining that the person is permitted access to the premises, causing a lock securing an access point of the premises to unlock.

13. The method of claim 12, wherein the audio passcode comprises one of:
a randomly generated sound signature that is generated by the at least one computing device; or
an inaudible sound signature that is generated by the at least one computing device.

14. The method of claim 12, wherein the optically capturable passcode comprises a quick response (QR) code that is downloadable to the mobile device associated with the person.

15. The method of claim 12, further comprising:
receiving an indication that the person is present at the premises;
in response to the indication, generating the optically capturable passcode;
transmitting the optically capturable passcode to the mobile device;
after transmitting the optically capturable passcode to the mobile device, generating the audio passcode; and
transmitting the audio passcode to the mobile device.

16. The method of claim 15, further comprising:
determining that the recorded audio corresponds to the generated audible passcode; and
in response to determining that the recorded audio corresponds to the generated audible passcode, deeming the person authenticated.

17. The method of claim 16, further comprising, in response to deeming the person authenticated and determining that the person is permitted access to the premises, causing a security alarm system at the premises to transition from an armed state to a disarmed state.

18. The method of claim 15, wherein the indication that the person is present at the premises corresponds to one of:
a message initiated by the person; or
an alert indicating that a recognized person has been detected at the premises.

19. The method of claim 12, further comprising:
determining that the optically capturable passcode in the image corresponds to the generated optically capturable passcode; and
in response to determining that the optically capturable passcode in the image corresponds to the generated optically capturable passcode, transmitting a message to a premises device of the premises monitoring system, the message being configured to cause the premises device to prompt the person to cause the mobile device to render the audio passcode.

20. The method of claim 12, further comprising capturing, by a premises device of the premises monitoring system, the optically capturable passcode and the audio passcode, the premises device is a video doorbell device that is proximate an access location of a premises.
